(19) United States
(12) Patent Application Publication
(10) Pub. No.: US 2013/0097543 A1
(43) Pub. Date: Apr. 18, 2013

(54) CAPTURE-AND-PASTE METHOD FOR ELECTRONIC DEVICE

(71) Applicant: Kdan Mobile Software Ltd., Tainan City (TW)

(72) Inventors: Po-Chou Su, Tainan City (TW); Chun-Chin Su, Kaohsiung City (TW); Yao-Ting Huang, Tainan City (TW); Wen-Wei Lin, Tainan City (TW)

(73) Assignee: Kdan Mobile Software Ltd., Tainan City (TW)

(21) Appl. No.: 13/647,960

(22) Filed: Oct. 9, 2012

(30) Foreign Application Priority Data
Oct. 14, 2011 (TW) 100137304

(51) Int. Cl. G06F 3/048

(52) U.S. Cl. 715/770

(57) ABSTRACT

A capture-and-paste method is implemented by a processor of an electronic device having a display unit. The processor executes at least one application and correspondingly enables display of at least one application window. The capture-and-paste method includes: defining a transparent working zone superimposed on the application window; moving the working zone onto a user-selected part of the application window; capturing the user-selected part of the application window to result in captured content; moving the working zone onto another user-selected part of the application window; and pasting the captured content onto the another user-selected part of the application window.

### CROSS-REFERENCE TO RELATED APPLICATION

This application claims priority to Taiwanese Application No. 100137304, filed on Oct. 14, 2011.

### BACKGROUND OF THE INVENTION

1. Field of the Invention

The invention relates to a method to be implemented using a computer, and more particularly to a capture-and-paste method for capturing and pasting desired content using the computer.

2. Description of the Related Art

Generally, when a user views a webpage using a tablet computer, images on the webpage may be saved by: (a) holding down the image displayed on the webpage, and selecting from a pop-up window to save the image into an image file, so that the image of the webpage is saved for further editing or use; or (b) saving the entire webpage into a document in portable document format (PDF), using a PDF reader software such as Adobe Acrobat to open the document for capturing the whole page that has the required image, and modifying the captured page as desired. However, the aforesaid two methods have the following drawbacks:

(1) It is necessary to create a folder in a storage device for storage of the saved image file. When it is desired to access the saved image file, the user has to find out where the created folder is, and to select the required file in the folder, resulting in inconvenience in use.

(2) When the desired image is not allowed to be downloaded, or is not displayed in an image file format on the webpage, although the desired image may still be obtained using the method (b), much time is needed to proceed with a series of complicated steps for processing the image, thereby resulting in inconvenience.

### SUMMARY OF THE INVENTION

Therefore, an object of the present invention is to provide a capture-and-paste method to be implemented using a processor of an electronic device.

According to one aspect of the present invention, a capture-and-paste method is to be implemented by a processor of an electronic device. The processor executes at least one application and enables a display unit of the electronic device to display at least one application window corresponding to the at least one application being executed by the processor on the display unit. The capture-and paste method comprises the steps of:

a) configuring the processor to define a working zone on the display unit, the working zone being superimposed on the application window that serves as an image source, the working zone having a transparent state, in which a part of the application window that underlies the working zone is visible through the working zone;

b) configuring the processor to move the working zone having the transparent state on the display unit to correspond in position to a user-selected part of the application window that serves as the image source in response to user instructions received by the processor;

c) configuring the processor to convert the working zone from the transparent state to a first image-capture state, in which the user-selected part of the application window that serves as the image source is captured by the working zone to result in captured content, in response to a user instruction received by the processor;

d) configuring the processor to move the working zone on the display unit to correspond in position to a user-selected part of the application window that serves as an editing target in response to user instructions received by the processor; and

e) configuring the processor to paste the captured content onto the user-selected part of the application window that serves as the editing target in response to a user instruction received by the processor.

According to another aspect of the present invention, a capture-and-paste tool is adapted for an electronic device having a processor. The processor executes at least one application and enabling a display unit of the electronic device to display at least one application window corresponding to the at least one application being executed by the processor on the display unit. The capture-and-paste tool comprises:

program instructions for configuring the processor to define a working zone on the display unit, the working zone being superimposed on the application window that serves as an image source, the working zone having a transparent state, in which a part of the application window that underlies the working zone is visible through the working zone;

program instructions for configuring the processor to move the working zone having the transparent state on the display unit to correspond in position to a user-selected part of the application window that serves as the image source in response to user instructions received by the processor;

program instructions for configuring the processor to convert the working zone from the transparent state to an image-capture state, in which the user-selected part of the application window that serves as the image source is captured by the working zone to result in captured content, in response to a user instruction received by the processor;

program instructions for configuring the processor to move the working zone on the display unit to correspond in position to a user-selected part of the application window that serves as an editing target in response to user instructions received by the processor; and

program instructions for configuring the processor to paste the captured content onto the user-selected part of the application window that serves as the editing target in response to a user instruction received by the processor.

### BRIEF DESCRIPTION OF THE DRAWINGS

Other features and advantages of the present invention will become apparent in the following detailed description of the preferred embodiment with reference to the accompanying drawings, of which:

FIGS. 1(A) to 1(C) are schematic diagrams illustrating program instructions of a capture-and-paste tool for implementation of the preferred embodiment of a capture-and-paste method according to the present invention;

FIG. 2 is a flow chart illustrating steps of the capture-and-paste method;

FIG. 3 is a schematic diagram showing a user interface of the capture-and-paste tool;

FIG. 4 is a schematic diagram showing the capture-and-paste tool executed on a tablet computer;

FIG. 5 is a schematic diagram showing the capture-and-paste tool superimposed on a user-selected part of an application window;

FIG. 6 is a schematic diagram illustrating a first capture instruction of the preferred embodiment;

FIG. 7 is a schematic diagram illustrating a paste instruction of the preferred embodiment;

FIG. 8 is a schematic diagram illustrating a data storage instruction of the preferred embodiment;

FIG. 9 is a schematic diagram illustrating that user-defined traces are generated in the working zone using handwriting and drawing functionality of an application;

FIG. 10 is a schematic diagram illustrating a second capture instruction of the preferred embodiment;

FIG. 11 is a schematic diagram illustrating a clear instruction of the preferred embodiment;

FIG. 12 is a schematic diagram illustrating a rotation instruction of the preferred embodiment;

FIG. 13 is a schematic diagram illustrating a window resizing instruction of the preferred embodiment;

FIG. 14 is a schematic diagram illustrating a resolution adjusting instruction of the preferred embodiment;

FIG. 15 is a schematic diagram illustrating an implementation of a capturing mode selection instruction of the preferred embodiment; and

FIG. 16 is a schematic diagram illustrating another implementation of the capturing mode selection instruction of the preferred embodiment.

### DETAILED DESCRIPTION OF THE PREFERRED EMBODIMENT

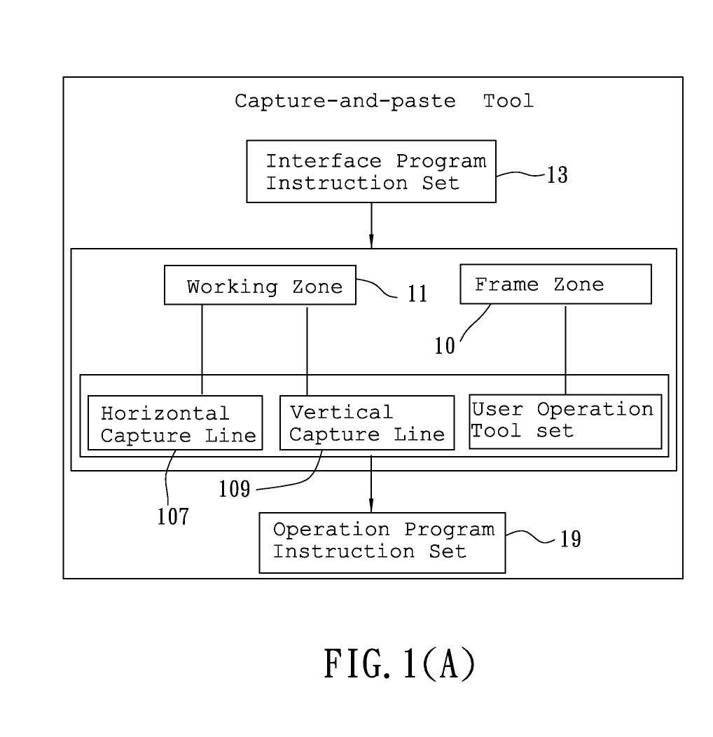

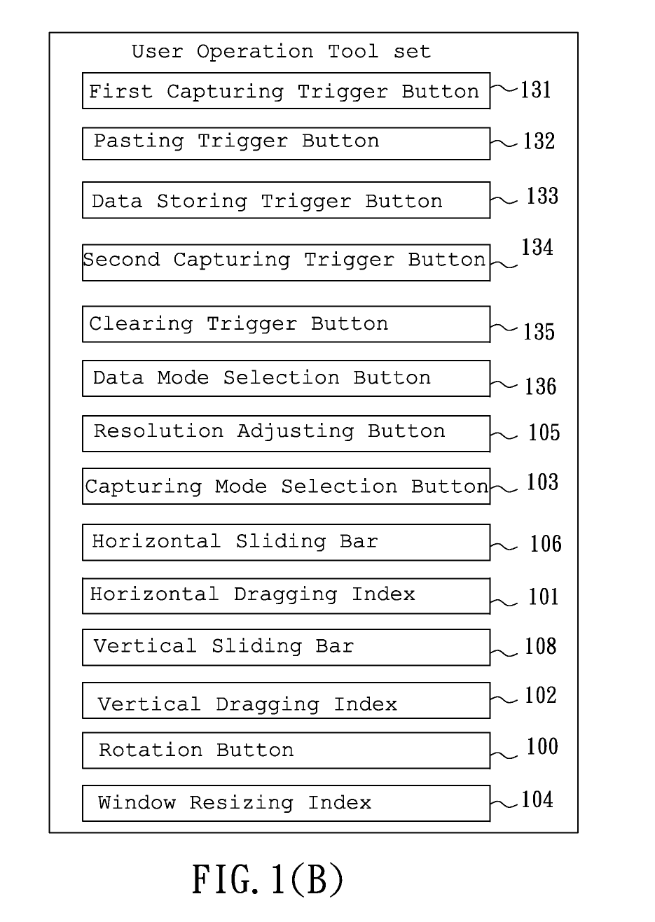

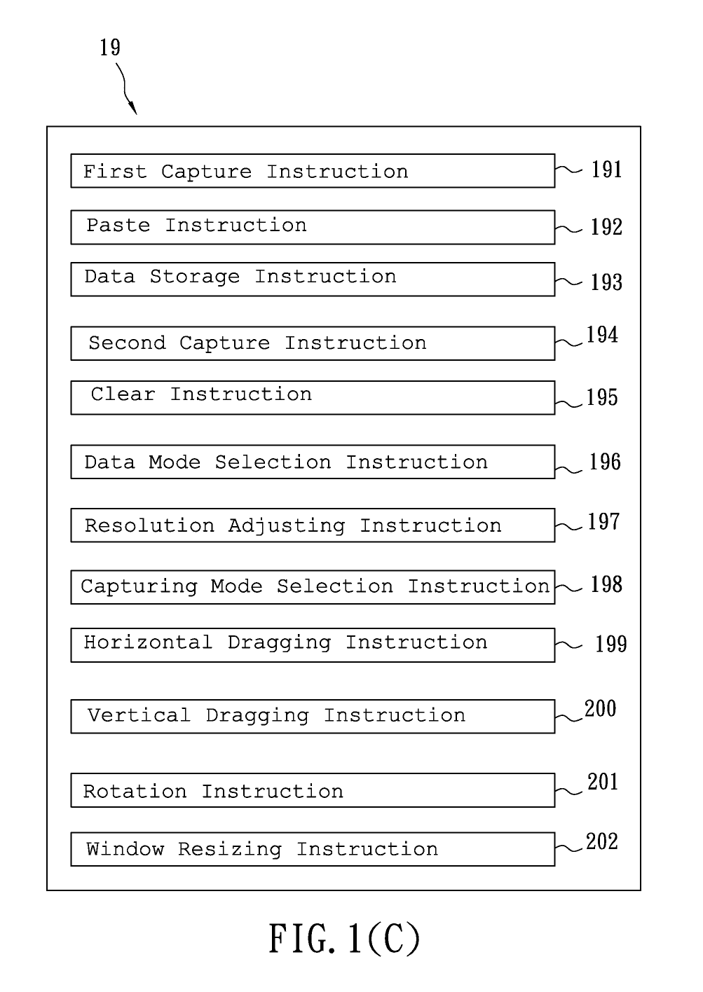

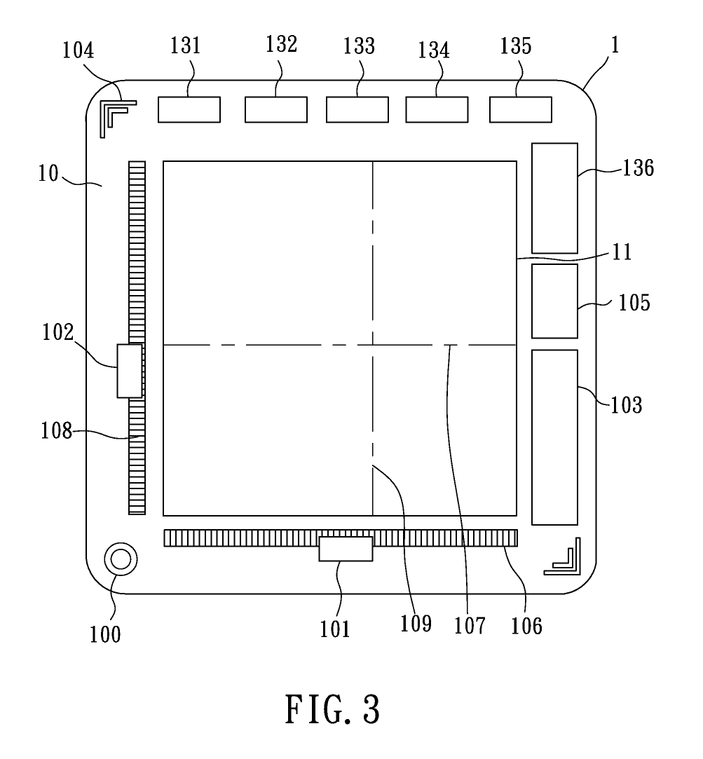

Referring to FIG. 1 to FIG. 4, the preferred embodiment of the capture-and-paste method according to this invention is implemented in a form of a capture-and-paste tool executed by a processor of an electronic device 9. The electronic device 9 may be a computer, a smart phone, a tablet computer, etc. Execution of the capture-and-paste tool by the processor enables display of a first application window 1 associated with the capture-and-paste tool on a display unit of the electronic device 9. In this embodiment, the capture-and-paste tool is a plug-in module of a computer web browser (such as Microsoft Internet Explorer, Google Chrome, Mozilla Firefox, or Apple Safari), a smartphone web browser (such as Safari for iPhone or Android browser), or a document reader (such as Adobe Acrobat Reader or Microsoft Office). That is, when the capture-and-paste tool is executed by the processor of the electronic device 9, the first application window 1 displayed on the display unit is movable above at least one second application window 4 that corresponds to at least one other application executed by the processor.

Referring to FIGS. 1(A) to 1(C), the capture-and-paste tool includes an interface program instruction set 13 and an operation program instruction set 19. The interface program instruction set 13 enables the processor to display a working zone 11, a frame zone 10 surrounding the working zone 11, and a user operation tool set that is disposed on the frame zone 10 on the display unit. The user operation tool set includes a first capturing trigger button 131, a pasting trigger button 132, a data storing trigger button 133, a second capturing trigger button 134, a clearing trigger button 135, a data mode selection button 136, a resolution adjusting button 105, a capturing mode selection button 103, a horizontal sliding bar 106, a vertical sliding bar 108, a horizontal dragging index 101, a vertical dragging index 102, a rotation button 100, and a window resizing index 104. The interface program instruction set 13 further enables display of a horizontal capture line 107 and a vertical line 109 on the working zone 11.

The operation program instruction set 19 enables the processor to perform operations in response to user instructions inputted through the interface program instruction set 13, and includes:

a first capture instruction 191 corresponding to the first capturing trigger button 131,

a paste instruction 192 corresponding to the pasting trigger button 132,

a data storage instruction 193 corresponding to the data storing trigger button 133,

a second capture instruction 194 corresponding to the second capturing trigger button 134,

a clear instruction 195 corresponding to the clearing trigger button 135,

a data mode selection instruction 196 corresponding to the data mode selection button 136,

a resolution adjusting instruction 197 corresponding to the resolution adjusting button 105,

a capturing mode selection instruction 198 corresponding to the capturing mode selection button 103,

a horizontal dragging instruction 199 associated with the horizontal sliding bar 106, the horizontal capture line 107, and the horizontal dragging index 101,

a vertical dragging instruction 200 associated with the vertical sliding bar 108, the vertical capture line 109, and the vertical dragging index 102,

a rotation instruction 201 corresponding to the rotation button 100, and

a window resizing instruction 202 corresponding to the window resizing index 104.

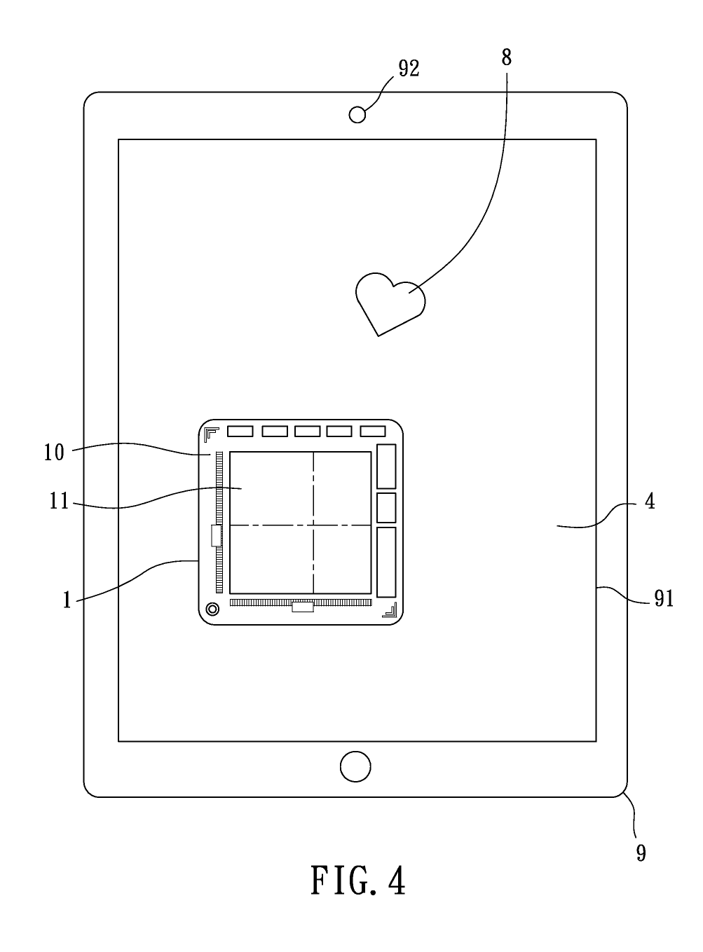

Accordingly, when the user provides the user instructions through the interface displayed on the display unit through the interface program instruction set 13, execution of the corresponding operation program instructions 191˜202 will be triggered to configure the processor to perform corresponding operations. Referring to FIG. 4, the electronic device 9 is exemplified as a touch device including a touch panel 91, so that the buttons 131˜135 are virtual control buttons using touch sensing technology. In other embodiments of this invention, the electronic device 9 may be configured such that the user may use hand gestures, voice control, or physical control buttons to generate the user instructions. However, the electronic device 9 may need a camera 92 for capturing the hand gestures from the user, and may need a microphone (not shown) for capturing voice instructions from the user, so as to be capable of determining which one of the operation program instructions is to be executed based upon the user's instructions.

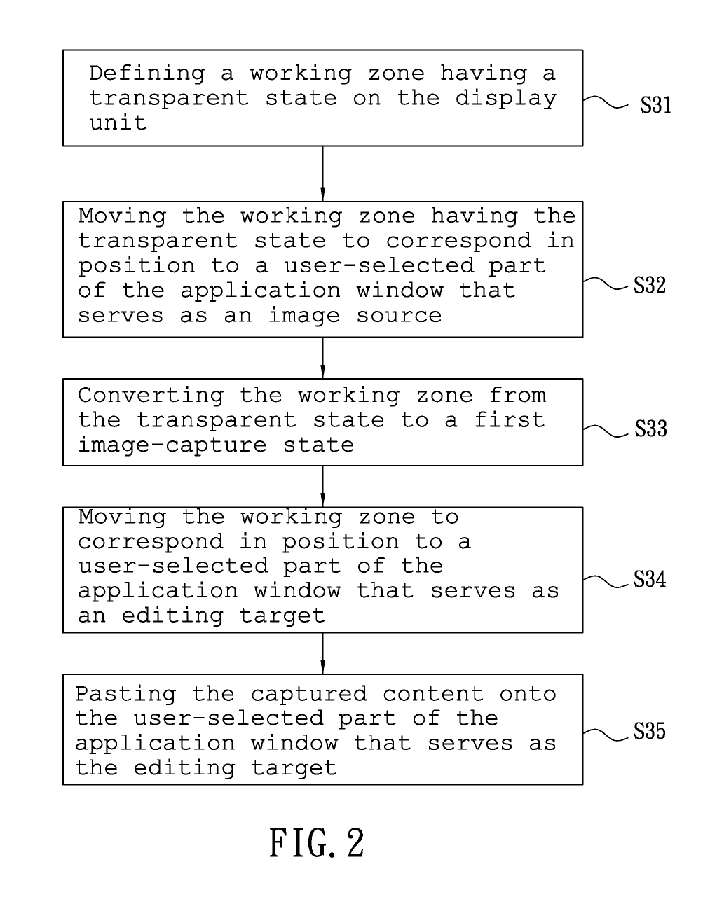

Referring to FIG. 1 and FIG. 2, the capture-and-paste method of this invention comprises the following steps, and FIGS. 4 to 16 illustrate operation results of the method that are displayed on the display unit. An image 8 included in the second application window 4 is used to describe effects of the program instructions.

Step S31: The processor is configured to define a working zone 11 on the display unit using the interface program instruction set 13. The working zone 11 is superimposed on the second application window 4 that serves as an image source, as shown in FIG. 4. The working zone 11 has a transparent state, in which a part of the second application window 4 that underlies the working zone 11 is visible through the working zone 11.

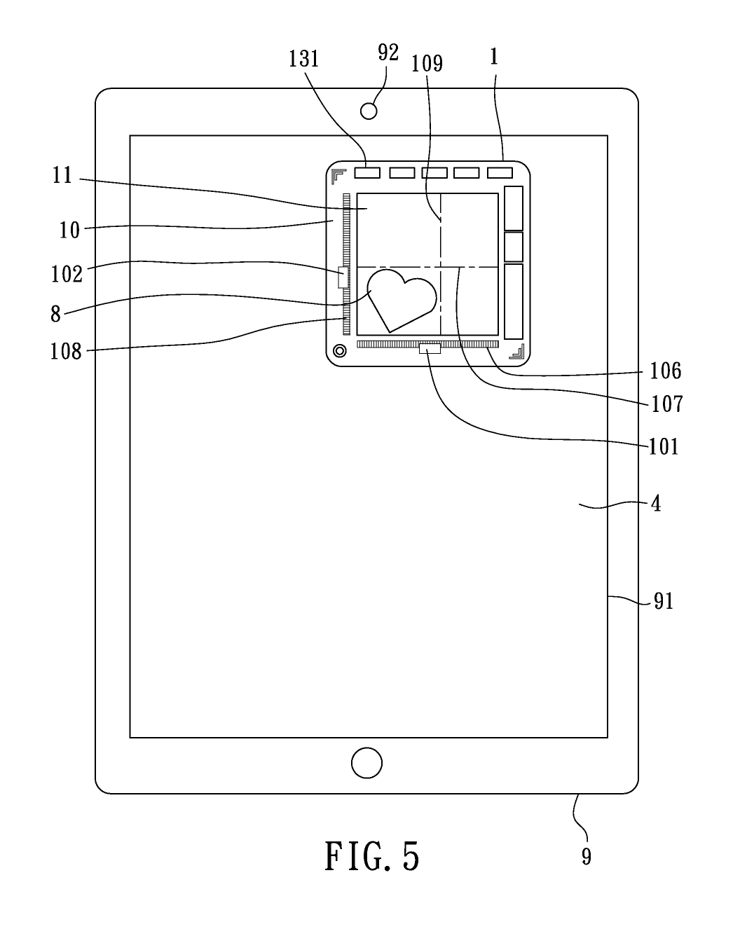

Step S32: The processor is configured to move the working zone 11 having the transparent state on the display unit to correspond in position to a user-selected part (as shown in FIG. 5) of the application window 4 that serves as the image source in response to user instructions received by the processor.

Step S33: The processor is configured to convert the working zone 11 from the transparent state to a first image-capture state, in which the user-selected part of the second application window 4 that serves as the image source is captured by the working zone 11 to result in captured content, in response to execution of the first capture instruction 191 by the processor as a result of selection of the first capturing trigger button 131 by the user.

In this embodiment, the working zone 11 is divided into four rectangular blocks by the horizontal capture line 107 and the vertical capture line 109, and the bottom-left block is defined as an effective capture area. Referring to FIGS. 1 and 5, the horizontal sliding bar 106 and the horizontal dragging index 101 correspond to the horizontal capture line 107, and the vertical sliding bar 108 and the vertical dragging index 102 correspond to the vertical capture line 109. Positions of the horizontal and vertical capture lines 107, 109 are adjustable by respectively dragging the horizontal and vertical dragging indexes 101, 102 along the horizontal and vertical sliding bars 106, 108 through the horizontal dragging instruction 199 and the vertical dragging instruction 200, such that size of the effective capture area of the working zone 11 is adjustable.

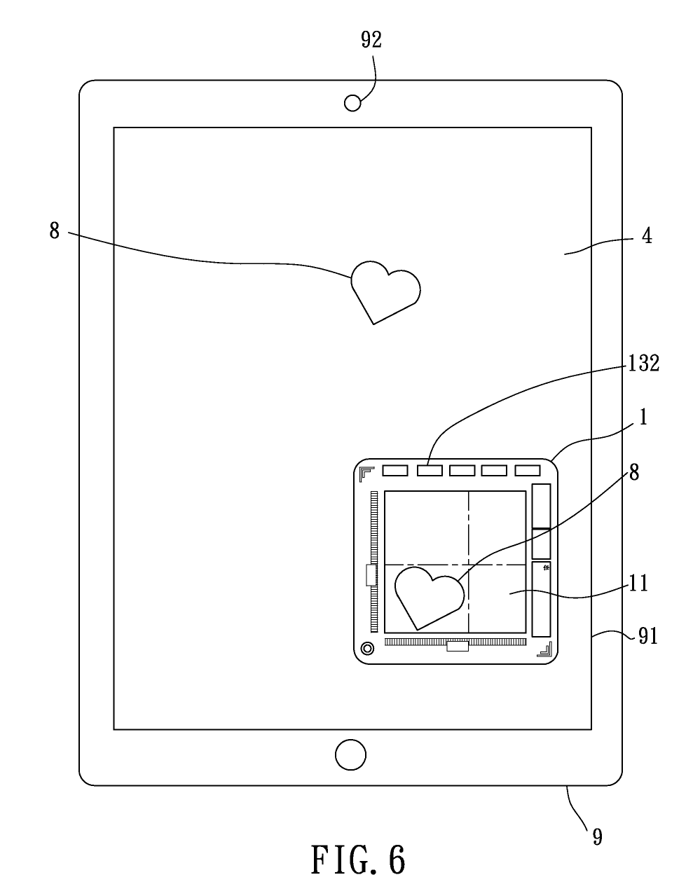

Step S34: The processor is configured to move the working zone 11 on the display unit to correspond in position to a user-selected part of the second application window 4 that serves as an editing target in response to user instructions received by the processor, as shown in FIG. 6. The captured content is moved with movement of the working zone 11 having the first image-capture state.

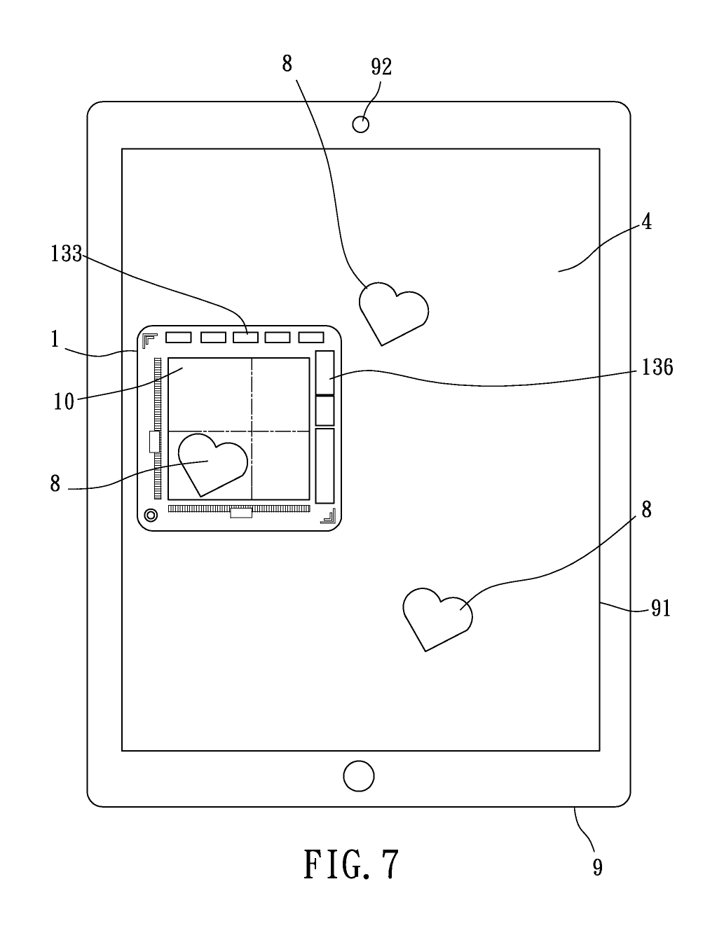

Step S35: The processor is configured to paste the captured content onto the user-selected part of the second application window 4 that serves as the editing target in response to execution of the paste instruction 192 by the processor as a result of selection of the pasting trigger button 132 by the user, as shown in FIG. 7. FIG. 7 shows that the captured content remains at the user-selected part of the second application window 4 shown in FIG. 6 when the working zone 11 having the first image-capture state is moved to another location.

It should be noted that, in this embodiment, the capture-and-paste tool for implementing the capture-and-paste method of this invention enables capturing of an image from the second application window 4, and pasting the captured image on another position of the second application window 4. In other embodiments, the capture-and-paste tool for implementing the capture-and-paste method of this invention may enable capturing of an image from the second application window 4 that serves as the image source, and pasting the captured image on another application window that serves as the editing target and that corresponds to another application, which differs from the application associated with the second application window 4.

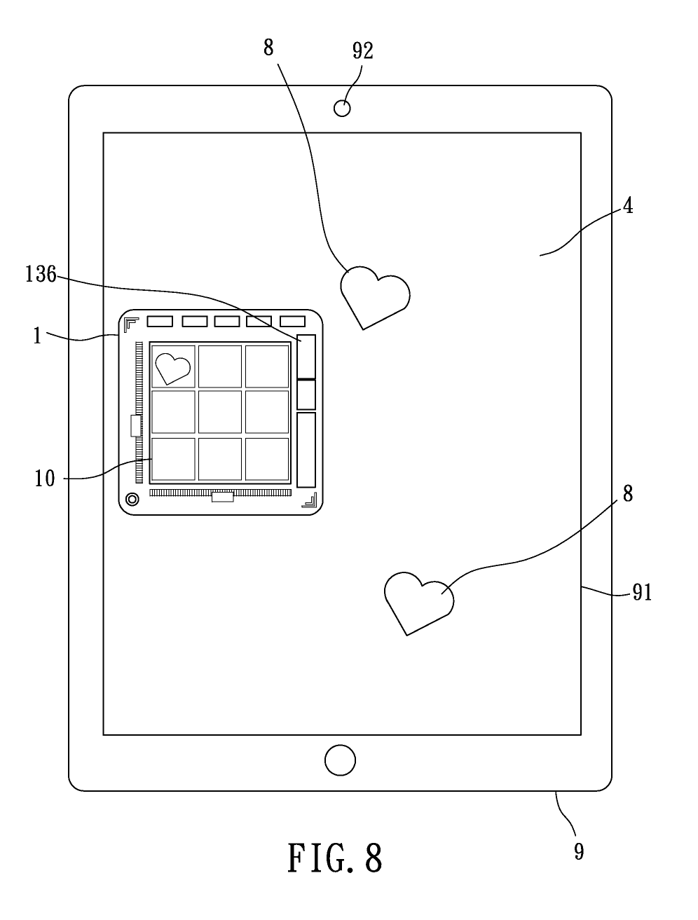

Referring to FIG. 8, the processor is configured to store the captured content in a storage medium of the electronic device 9 and to enable the display unit for displaying the captured content stored in the storage medium and to enable user selection of the captured content displayed on the display unit when the working zone 11 is in the first image-capture state and the processor executes the data storage instruction 193 as a result of selection of the data storing trigger button 133 by the user. The captured content may be stored in a multimedia data format of a text, an image, an audio, or a video. For example, when the data storage instruction 193 is executed followed by execution of the data mode selection instruction 196 as a result of selection of the data mode selection button 136 in a condition as illustrated in FIG. 7, the captured content is displayed as a thumbnail in the working zone 11 for selection by the user, as shown in FIG. 8. In addition, the user may switch options through execution of the data mode selection instruction 196 to obtain default data (not shown) stored in the storage medium.

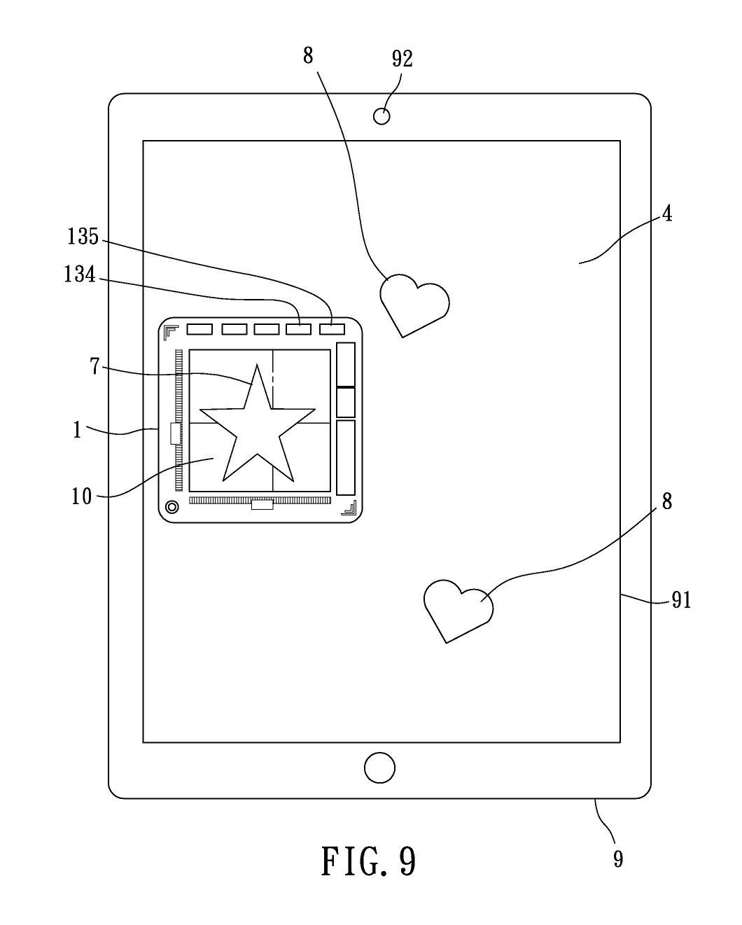

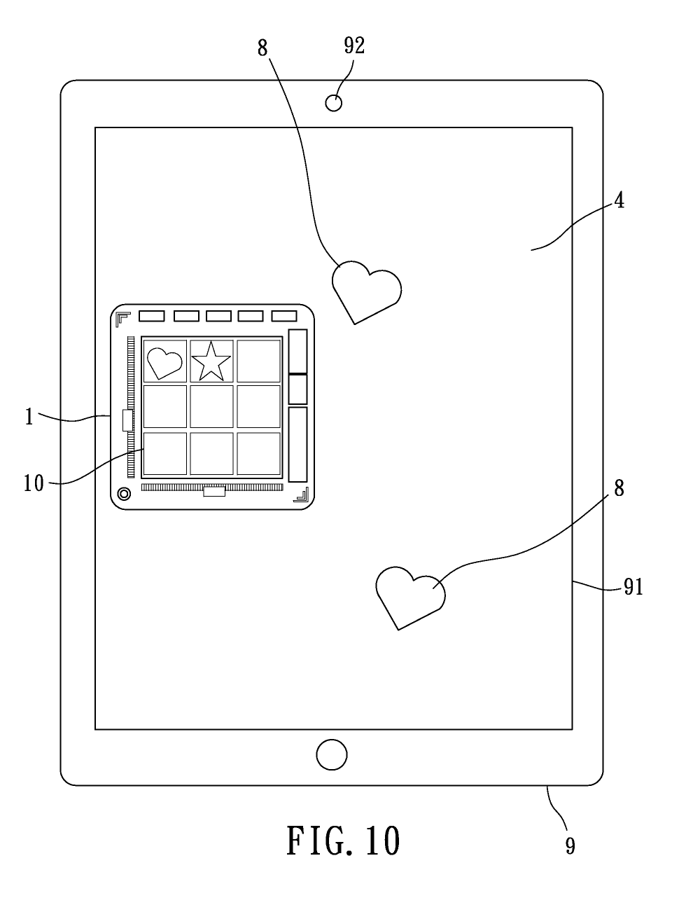

Referring to FIG. 9, when the application associated with the second application window 4 that serves as the image source has handwriting or drawing functionality, the processor is able to be configured using the second capture instruction 194 associated with the second capturing trigger button 134 to convert the working zone 11 from the transparent state to a second image-capture state, in which user-defined traces (such as the drawing 7 shown in FIG. 9) that are generated using the handwriting or drawing functionality and that are located in the working zone 11 are captured by the working zone 11 to result in captured content that is stored in the storage medium, and the processor enables user selection of the captured content displayed on the display unit, as shown in FIG. 10.

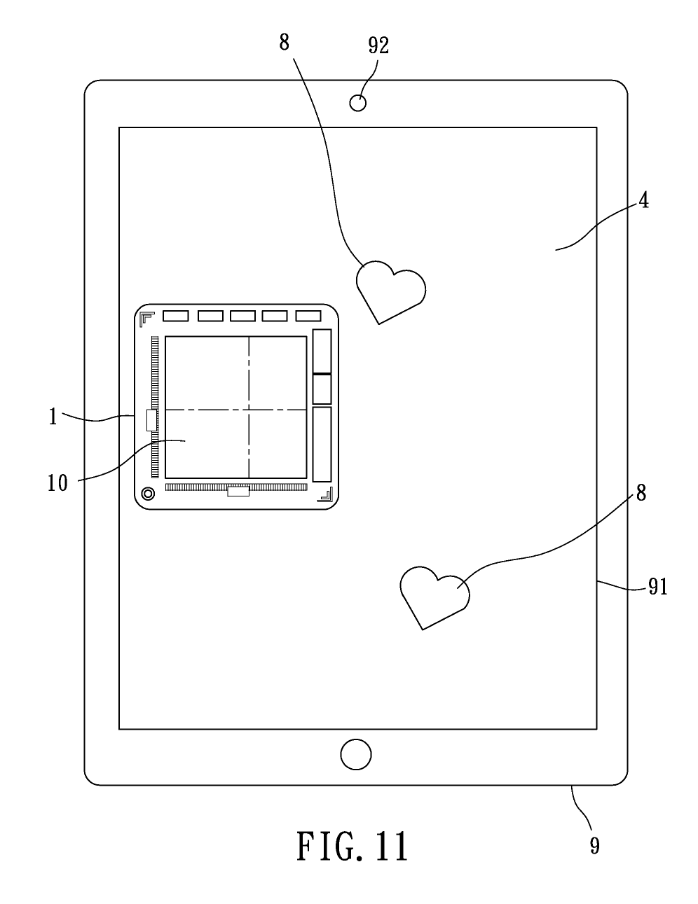

Referring to FIG. 11, the processor is able to be configured to convert the working zone 11 from the first image-capture state or the second image-capture state back to the transparent state in response to execution of the clear instruction 195 as a result of selection of the clearing trigger button 135 by the user. For example, when the clearing trigger button 135 is triggered in a state as shown in FIG. 9, the drawing 7 in the working zone 11 is cleared to result in a state as shown in FIG. 11.

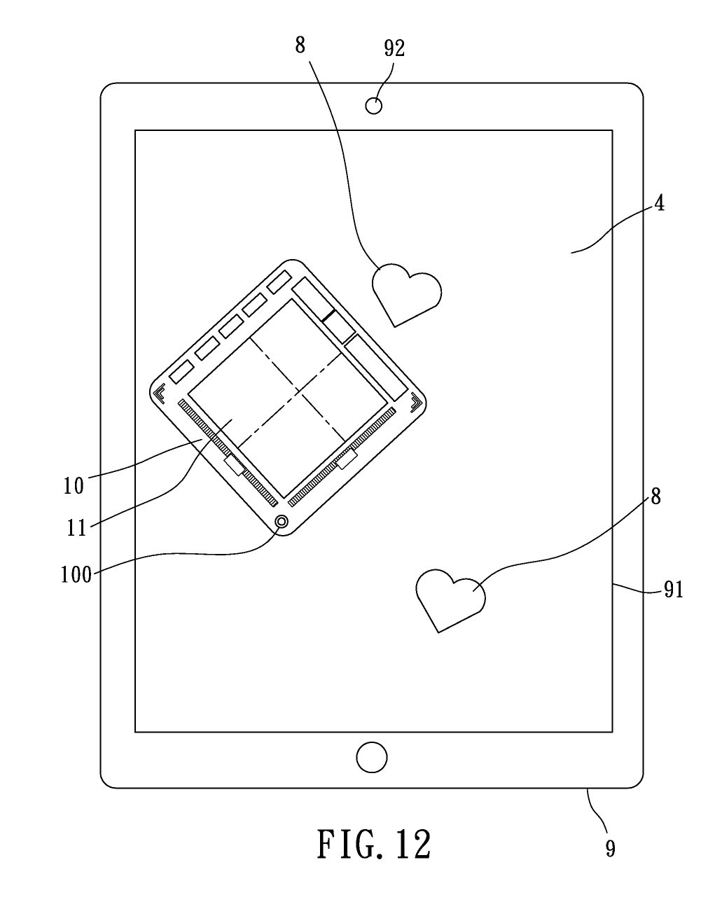

Referring to FIG. 12, the processor is able to be configured to rotate the working zone 11 on the display unit in response to execution of the rotation instruction 201 as a result of user operation of the rotation button 100. That is, the frame zone 10 and the working zone 11 are both rotated around a center of the working zone 11 by holding and dragging the rotation button 100. However, execution of the rotation instruction 201 may also be triggered using multi-touch technology, such that the frame zone 10 and the working zone 11 are both rotated around the center of the working zone 11.

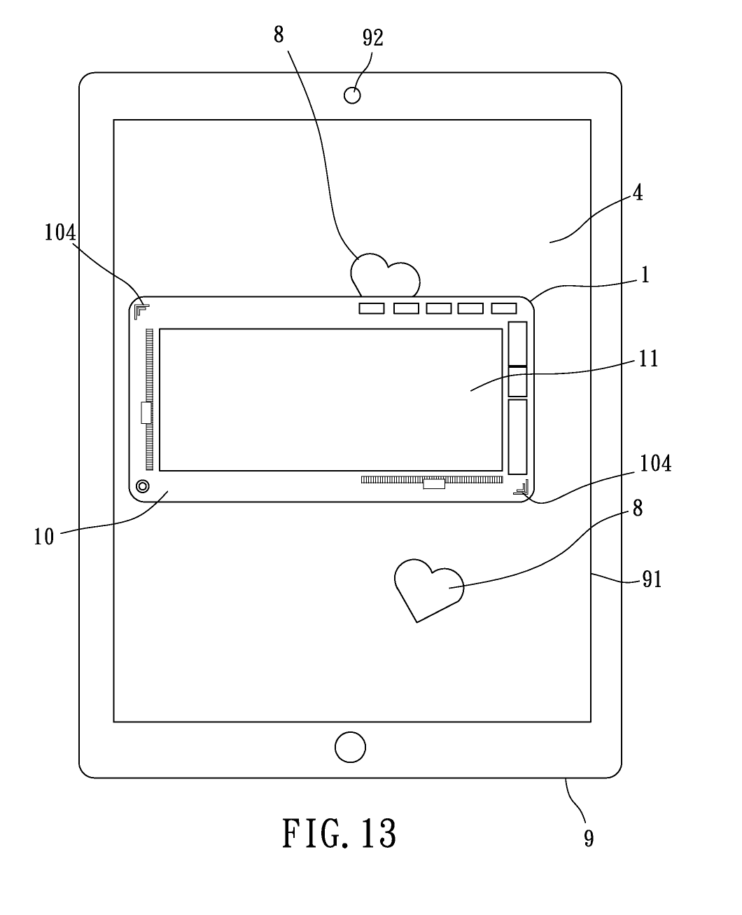

Referring to FIG. 13, the window resizing index 104 may be held and dragged by the user to trigger execution of the window resizing instruction 202 that configures the processor to adjust size of the first application window 1 and the working zone 11.

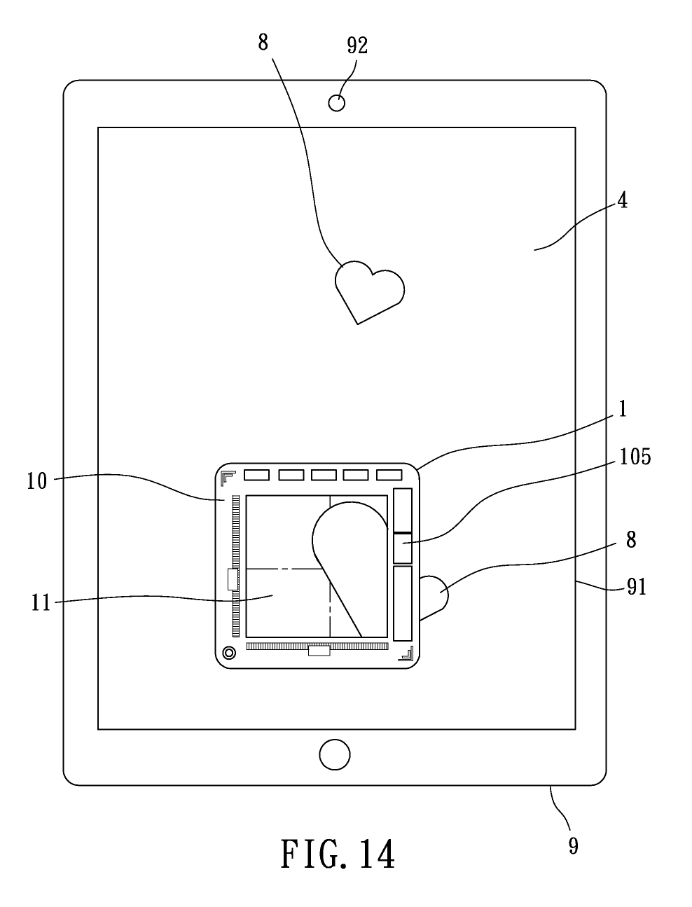

Referring to FIG. 14, the resolution adjusting button 105 may be used to trigger execution of the resolution adjusting instruction 197 to configure the processor to adjust size of content of the second application window 4 visible through the working zone 11. In this embodiment, the range of size adjustment is between 0.8 times and 5 times.

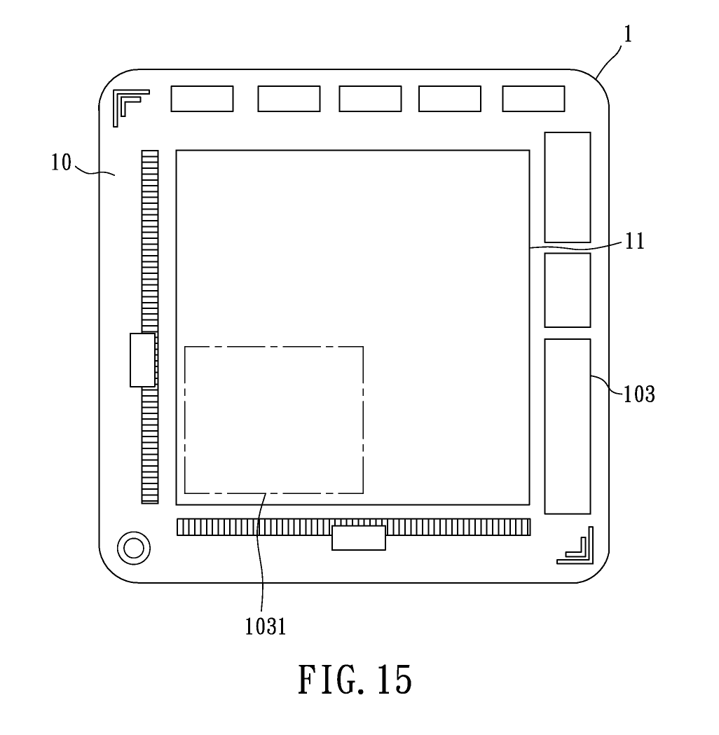

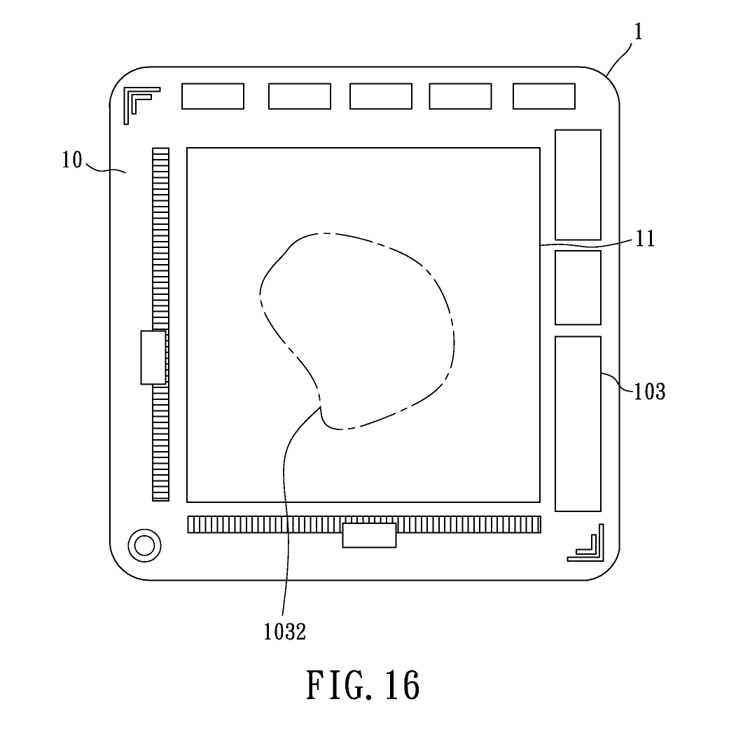

In other embodiments of this invention, the effective capture area of the working zone 11 may be defined using other methods. In one implementation, by triggering the capturing mode selection button 103 to select a rectangular capturing mode, the capturing mode instruction 198 is executed to configure the processor to display a rectangular capture frame 1031 in the working zone 11, as shown in FIG. 15. Size and aspect ratio of the rectangular capture frame 1031 may be adjusted by holding and dragging to define the effective capture area. In another implementation, by triggering the capturing mode selection button 103 to select an arbitrary-shape capturing mode, the capturing mode instruction 198 is executed to configure the processor to allow the user to draw a user-defined shape in the working zone 11, and to convert the user-defined shape into a closed capture frame 1032 having the same shape as the user-defined shape to define the effective capture area, as shown in FIG. 16.

To sum up, the capture-and-paste method implemented by the processor of an electronic device 9 according to the present invention may be operated through hand gestures, voice control, physical control buttons, or virtual control buttons, and has the following advantages: (1) the content of the underlying application windows is easily and quickly captured into the working zone 11, and then is easily and quickly pasted onto another position of the underlying application windows; (2) the capture-and-paste method of this invention provides easy operation and solves the problem that images are not allowed to be downloaded when the images are not stored in image file formats; (3) the captured content captured by the working zone can be stored into the storage medium of the electronic device 9 for future use; (4) compared to conventional methods, operation of the capture-and-paste method of this invention is relatively simple, and is time-saving in terms of finding files from folders; and (5) the capture-and-paste method of this invention is able to configure the processor to store user-defined traces generated using the handwriting and drawing functionality of the application associated with the underlying application window into the storage medium of the electronic device 9 for further use.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A capture-and-paste method to be implemented by a processor of an electronic device, the processor executing at least one application and enabling a display unit of the electronic device to display at least one application window corresponding to the at least one application being executed by the processor on the display unit, the capture-and-paste method comprising the steps of:
a) configuring the processor to define a working zone on the display unit, the working zone being superimposed on the application window that serves as an image source, the working zone having a transparent state, in which a part of the application window that underlies the working zone is visible through the working zone;
b) configuring the processor to move the working zone having the transparent state on the display unit to correspond in position to a user-selected part of the application window that serves as the image source in response to user instructions received by the processor;
c) configuring the processor to convert the working zone from the transparent state to a first image-capture state, in which the user-selected part of the application window that serves as the image source is captured by the working zone to result in captured content, in response to a user instruction received by the processor;
d) configuring the processor to move the working zone on the display unit to correspond in position to a user-selected part of the application window that serves as an editing target in response to user instructions received by the processor; and
e) configuring the processor to paste the captured content onto the user-selected part of the application window that serves as the editing target in response to a user instruction received by the processor.

2. The capture-and-paste method as claimed in claim 1, wherein:
step c) includes configuring the processor to store the captured content in a storage medium; and
the capture-and-paste method further comprises, prior to step e), the step of
f) configuring the processor to enable the display unit for displaying the captured content stored in the storage medium and to enable user selection of the captured content displayed on the display unit.

3. The capture-and-paste method as claimed in claim 2, wherein the captured content is displayed in the working zone in step f).

4. The capture-and-paste method as claimed in claim 3, wherein the captured content is displayed as a thumbnail in step f).

5. The capture-and-paste method as claimed in claim 2, the application associated with the application window that serves as the image source having at least one of handwriting and drawing functionality, said capture-and-paste method further comprising the step of, prior to step f):
configuring the processor to convert the working zone from the transparent state to a second image-capture state, in which user-defined traces that are generated using the at least one of the handwriting and drawing functionality and that are located in the working zone are captured by the working zone to result in captured content that is stored in the storage medium, in response to a user instruction received by the processor.

6. The capture-and-paste method as claimed in claim 5, further comprising the step of:
configuring the processor to convert the working zone from one of the first image-capture state and the second image-capture state back to the transparent state in response to a user instruction received by the processor.

7. The capture-and-paste method as claimed in claim 1, wherein the user instructions in at least one of steps b) to e) are generated using at least one of hand gestures, voice control, physical control buttons, and virtual control buttons.

8. The capture-and-paste method as claimed in claim 1, wherein at least one of steps b) and d) includes:
configuring the processor to rotate the working zone on the display unit in response to the user instructions received by the processor.

9. The capture-and-paste method as claimed in claim 1, wherein at least one of steps b) and d) includes:
configuring the processor to adjust at least one of size and shape of an effective capture area of the working zone in response to the user instructions received by the processor.

10. The capture-and-paste method as claimed in claim 1, wherein at least one of steps b) and d) includes:
configuring the processor to adjust size of the working zone in response to the user instructions received by the processor.

11. The capture-and-paste method as claimed in claim 1, further comprising the step of:
configuring the processor to adjust size of content of the underlying application window visible through the working zone in response to user instructions received by the processor.

12. A capture-and-paste tool for an electronic device having a processor, the processor executing at least one application and enabling a display unit of the electronic device to display at least one application window corresponding to the at least one application being executed by the processor on the display unit, the capture-and-paste tool comprising:
program instructions for configuring the processor to define a working zone on the display unit, the working zone being superimposed on the application window that serves as an image source, the working zone having a transparent state, in which a part of the application window that underlies the working zone is visible through the working zone;
program instructions for configuring the processor to move the working zone having the transparent state on the display unit to correspond in position to a user-selected part of the application window that serves as the image source in response to user instructions received by the processor;
program instructions for configuring the processor to convert the working zone from the transparent state to an image-capture state, in which the user-selected part of the application window that serves as the image source is captured by the working zone to result in captured content, in response to a user instruction received by the processor;
program instructions for configuring the processor to move the working zone on the display unit to correspond in position to a user-selected part of the application window that serves as an editing target in response to user instructions received by the processor; and
program instructions for configuring the processor to paste the captured content onto the user-selected part of the application window that serves as the editing target in response to a user instruction received by the processor.

13. A capture-and-paste method to be implemented by a processor of an electronic device, the processor executing at least one application and enabling a display unit of the electronic device to display at least one application window corresponding to the at least one application being executed by the processor on the display unit, the capture-and-paste method comprising the steps of:
a) configuring the processor to define a working zone on the display unit, the working zone being superimposed on the application window that serves as an image source, the working zone having a transparent state, in which a part of the application window that underlies the working zone is visible through the working zone;
b) configuring the processor to convert the working zone from the transparent state to a first image-capture state, in which the part of the application window that underlies the working zone is captured by the working zone to result in captured content, in response to a user instruction received by the processor; and
c) configuring the processor to paste the captured content onto the application window that serves as an editing target in response to a user instruction received by the processor.

14. The capture-and-paste method as claimed in claim 13, further comprising the step of, prior to step c):
configuring the processor to move the working zone on the display unit to the application window that serves as the editing target in response to user instructions received by the processor.
